(19) United States
(12) Patent Application Publication
(10) Pub. No.: US 2003/0098870 A1
(43) Pub. Date: May 29, 2003

(54) Linear Filter circuit

(76) Inventor: Michio Komoda, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/141,923

(22) Filed: May 10, 2002

(30) Foreign Application Priority Data
Nov. 27, 2001 (JP) 2001-361291

(51) Int. Cl. G09G 5/02

(52) U.S. Cl. 345/589

(57) ABSTRACT

In the linear filter circuit, a right shift circuit derives A×2⁻ⁿ by shifting the input pixel value A rightward by n bits. A selector selects either the input pixel value A or an input pixel value B according to an n-bit blending factor α, conducts computation of (A×α_+B×α), and outputs n partial products. A Wallace adder adds up a total of (n+1) partial products output from the selector and the right shift circuit, and thereby derives an output value Y=A×(1−α)+B×α of the linear filter circuit.

### FIELD OF THE INVENTION

The present invention relates to a linear filter circuit used in image processing such as 3D graphics. In particular, this invention relates to the linear filter circuit in which the number of adders and the number of stages used to add partial products can be reduced.

### BACKGROUND OF THE INVENTION

In the field of image processing, such as 3D graphic processing, processing (alpha blending) of blending color data for a transparent substance located on this side on the screen with color data for a substance located on the further side on the screen is executed in order to conduct semitransparent processing of displaying the transparent substance located on this side on the screen. Supposing color data (a pixel value) of the substance located on this side to be A, color data (a pixel value) of the substance located on the further side to be B, and a blending value (alpha value) which represents transparency to be α, the blending processing is implemented by executing processing represented by the following equation (1) in a linear filter circuit

Y=A×(1−α)+B×α (1)

where A and B are integers, and α is a decimal represented as 0.xxxx.

As for A, B, α and Y, specifications, such as the number of bits, handling only positive numerical values as A, B and α, and handling both positive and negative numerical values as A, B and α, depend on the graphic system to be used. Assuming that 10-bit positive integers are used as A, B and Y and a decimal having five bits after the decimal point is used as α, and 10 high-order bits are output as Y, a conventional linear filter circuit will now be explained.

The equation (1) is rewritten as

Y=A−A×α+B×α (2)

A circuit according to the equation (2) may be implemented by using two multipliers and two adders (including subtracters). However, since the area of the circuit and the delay value of signal transmission typically increase, letting

α=α₁2⁻¹+α₂2⁻²+α₃2⁻³+α₄2⁻⁴+α₅2⁻⁵

the equation (2) is further rewritten as represented by equation (3). “A_” denotes bit inverted data of A.

$$\begin{matrix}Y = A + ( A\_ + 1 ) α + B \times α \\ = A + α + A\_ \times ( {α}_{1} {2}^{- 1} + {α}_{2} {2}^{- 2} + {α}_{3} {2}^{- 3} + {α}_{4} {2}^{- 4} + {α}_{5} {2}^{- 5} ) + \\ B \times ( {α}_{1} {2}^{- 1} + {α}_{2} {2}^{- 2} + {α}_{3} {2}^{- 3} + {α}_{4} {2}^{- 4} + {α}_{5} {2}^{- 5} ) \\ = A + α + {A\_α}_{1} {2}^{- 1} + {A\_α}_{2} {2}^{- 2} + {A\_α}_{3} {2}^{- 3} + {A\_α}_{4} {2}^{- 4} + \\ {A\_α}_{5} {2}^{- 5} + B \times {α}_{1} {2}^{- 1} + B {α}_{2} {2}^{- 2} + B {α}_{3} {2}^{- 3} + B {α}_{4} {2}^{- 4} + B {α}_{5} {2}^{- 5}\end{matrix} \qquad ( 3 )$$

In the equation (3), for example, B×α₁ becomes 0 when. α₁ is 0, whereas B×α₁ becomes B when α₁ is 1. In other words, B×α₁ is implemented by logically AND-ing each of bits B₉ to B₀ of B and α₁ as shown in FIG. 5, and these are called partial products. If all of twelve partial products in the equation (3) are added up with due regard to figure alignment and an eleventh bit is discarded, then the value of Y to be derived is obtained.

As the method of adding the partial products, for example, the Wallace tree scheme using the carry save adder (CSA) can be mentioned. By adding up the generated partial products by using the Wallace tree scheme, a faster speed and a reduced area can be accomplished. As shown in FIG. 6, the carry save adder (CSA) has a logical structure which adds up three inputs to be added (an augend sequence Aᵢⱼ to Aᵢ₀, an addend sequence Bᵢⱼ to Bᵢ₀, and a carry-in sequence Cᵢⱼ to Cᵢ₀), by using a full adder, and thereby narrows down them to two numbers, i.e., a sum sequence Sᵢⱼ to Sᵢ₀ ic and a carry-out sequence Coᵢⱼ to Coᵢ₀.

If the Wallace tree scheme using such a carry save adder (CSA) is used, and twelve partial products P1 to P12 exist as represented by the equation (3), then the configuration of the Wallace tree becomes as shown in FIG. 7.

With reference to FIG. 7, in a first stage, twelve partial products P1 to P12 can be narrowed down to eight partial products by using four CSAs. In a second stage, two CSAs are used for six partial products among the eight partial products obtained by the narrowing down, and thus the eight partial products are narrowed down to 4+2 partial products. In a third stage, the six partial products are narrowed down to four partial products by using two CSAs. In a fourth stage, the four partial products are narrowed down to 1+2 partial products by using one CSA. In a fifth stage, the three partial products are narrowed down to two partial products by using one CSA. A final sum is obtained by using an ordinary full adder for the two numbers. By taking 10 high-order bits of the resultant sum, Y to be derived is obtained.

In this way, when a linear filter circuit is formed by using the equation (3), the circuit which generates twelve partial products, the five-stage Wallace tree using ten CSAs, and the full adder are needed.

In the conventional art, however, partial products such as B×α₁ are derived by logically AND-ing two inputs B and α₁. When α has n bits, at least 2 n partial products are generated and these 2 n partial products need be added up. Therefore, the number of CSAs and the number of stages in the Wallace tree become large. This results in a problem that fast operation is hindered and the area of the circuit is increased.

### SUMMARY OF THE INVENTION

It is an object of the present invention to provide a linear filter circuit capable of achieving fast processing and reduction of the area of the circuit.

The linear filter circuit according to one aspect of this invention uses two input pixel values A and B and an n-bit blending factor a (decimal), computes Y=A×(1−α)+B×α (where A and B are integers), and thereby blends the two input pixel values. This linear filter circuit comprises a shift circuit which shifts the input pixel value A rightward by n bits, a selector which selects either the input pixel value A and the input pixel value B according to the n-bit blending factor α and outputs n partial products, and an adder which adds up a total of (n+1) partial products between output from the selector and output from the shift circuit.

The equation Y=A×(1−α)+B×α (where A and B are integers) can be rewritten as Y=A×(α_{—}+2⁻ⁿ)+B×α=A×2⁻ⁿ+(A×α_+B×α), where α_ is bit inverted data of α. According to the first aspect, the shift circuit derives A×2⁻ⁿ by shifting the input pixel value A rightward by n bits. The selector selects either the input pixel value A or the input pixel value B according to the n-bit blending factor α, and conducts computation of (A×α_+B×α) to output n partial products. The adder adds up a total of (n+1) partial products output from the selector and the shift circuit, and thereby derives the output value Y of the equation. As a result, the number of generated partial products becomes (n+1), and the number is reduced as compared with the conventional art. Accordingly, a linear filter circuit having a faster speed and a reduced area can be implemented.

In the above-mentioned linear filter circuit, carry save adders of multiple stages of a Wallace tree scheme are used in the adder.

According to the above aspect, a plurality of partial products are added up by using the carry save adders of multiple stages of the Wallace tree scheme. By the number of partial products reduced as compared with the conventional art, the number of carry save adders and the number of stages thereof can be reduced.

Other objects and features of this invention will become apparent from the following description with reference to the accompanying drawings.

### BRIEF DESCRIPTION OF THE DRAWINGS

FIG. 1 is a block diagram showing an embodiment of the linear filter circuit according to the present invention,

FIG. 2 is a diagram showing an internal configuration of a selector,

FIG. 3 is a diagram showing an internal configuration of a Wallace tree adder,

FIG. 4 is a diagram showing a configuration example of another adder,

FIG. 5 is a circuit diagram which derives a partial product in the conventional art,

FIG. 6 is a diagram showing a carry save adder, and

FIG. 7 is a diagram showing the Wallace tree adder according to the conventional art.

### DETAILED DESCRIPTIONS

An embodiment of the linear filter circuit according to the present invention will be explained in detail by referring to the accompanying drawings.

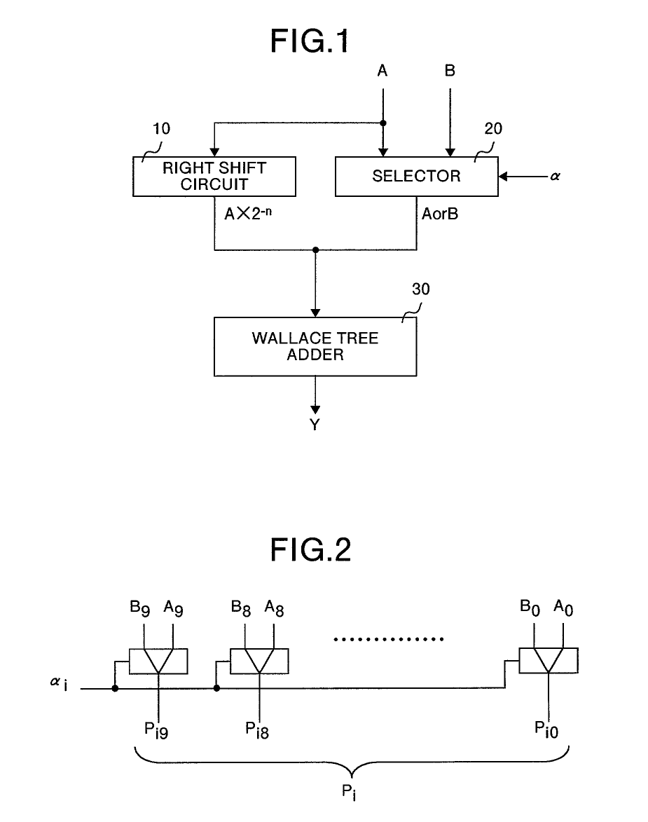

FIG. 1 is a diagram showing the embodiment of the linear filter circuit according to the present invention. The linear filter circuit shown in FIG. 1 is applied to blending processing having A as color data (a pixel value) of a substance located on this side, B as color data (a pixel value) of a substance located on the further side, and α as a blending value (alpha value) which represents transparency. The processing represented by the following equation (1) is conducted to obtain a blending output value Y.

Y=A×(1−α)+B×α (1)

where A and B are integers, and a is a decimal.

In the present embodiment, the equation (1) is rewritten as heretofore explained. A decimal having five bits after the decimal point (n=5) is used as α. It is assumed that 10-bit positive integers are used as A, B and Y and 10 high-order bits are output as Y.

As for (1−α), the following relation is utilized,

(1−α)=α_{1—}2⁻¹+α_{2—}2⁻²+α_{3—}2⁻³+α_{4—}2⁻⁴+α_{5—}2⁻⁵+2⁻⁵ (4)

where “α_” is bit inverted data of α.

This can be confirmed by making sure that 1 is obtained if α is added to the right side. That is,

$$α + {α}_{1} \_ {2}^{- 1} + {α}_{2} \_ {2}^{- 2} + {α}_{3} \_ {2}^{- 3} + {α}_{4} \_ {2}^{- 4} + {α}_{5} \_ {2}^{- 5} + {2}^{- 5} = ( {α}_{1} {2}^{- 1} + {α}_{2} {2}^{- 2} + {α}_{3} {2}^{- 3} + {α}_{4} {2}^{- 4} + {α}_{5} {2}^{- 5} ) + ( {α}_{1} \_ {2}^{- 1} + {α}_{2} \_ {2}^{- 2} + {α}_{3} \_ {2}^{- 3} + {α}_{4} \_ {2}^{- 4} + {α}_{5} \_ {2}^{- 5} + {2}^{- 5} ) = ( α + {α}_{1} \_ ) {2}^{- 1} + ( {α}_{2} + {α}_{2} \_ ) {2}^{- 2} + ( {α}_{3} + {α}_{3} \_ ) {2}^{- 3} + ( {α}_{4} + {α}_{4} \_ ) {2}^{- 4} + ( {α}_{5} + {α}_{5} \_ ) {2}^{- 5} + {2}^{- 5} = {2}^{- 1} + {2}^{- 2} + {2}^{- 3} + {2}^{- 4} + {2}^{- 5} + {2}^{- 5} = 1$$

Substituting the equation (4) into the equation (1) and rewriting a resultant equation, we get the following equation.

$$\begin{matrix}Y = A \times ( 1 - α ) + B \times α \\ = A \times ( {α}_{1} \_ {2}^{- 1} + {α}_{2} \_ {2}^{- 2} + {α}_{3} \_ {2}^{- 3} + {α}_{4} \_ {2}^{- 4} + {α}_{5} \_ {2}^{- 5} + {2}^{- 5} ) + \\ B \times ( {α}_{1} {2}^{- 1} + {α}_{2} {2}^{- 2} + {α}_{3} {2}^{- 3} + {α}_{4} {2}^{- 4} {α}_{5} \_ {2}^{- 5} ) \\ = A \times {2}^{- 5} + ( A {α}_{1} \_ + B {α}_{1} ) {2}^{- 1} + ( A {α}_{2} \_ + B {α}_{2} ) {2}^{- 2} + ( A {α}_{3} \_ + B {α}_{3} ) {2}^{- 3} + \\ ( A {α}_{4} \_ + B {α}_{4} ) {2}^{- 4} + ( A {α}_{5} \_ + B {α}_{5} ) {2}^{- 5}\end{matrix} \qquad ( 5 )$$

The equation (5) becomes a logical equation which forms a linear filter circuit of the present embodiment shown in FIG. 1.

In the equation (5), A×2⁻ⁿ can be implemented by shifting A rightward by n bits. In this case, n=5. A right shift circuit 10 shown in FIG. 1 shifts the input pixel value A rightward by n bits. The operation of A×2⁻ⁿ is implemented by this right shift.

In the equation (5), (Aα_{i—}+Bαᵢ) can be interpreted as a selector which selects A when αᵢ is 0 and selects B when αᵢ 1, where i=1 to n. A selector 20 shown in FIG. 1 selects either an input pixel value A or B according to a blending coefficient αᵢ. (Aα_{i—}+Bαᵢ) is implemented by this selection operation.

FIG. 2 shows an internal configuration of the selector 20 which selects one of the input pixel values A (A₀ to A₉) and B (B₀ to B₉) each having 10 bits according to a 1-bit blending coefficient αᵢ. A selected 9-bit output Pᵢ₀ to Pᵢ₉ is output as one partial product Pᵢ.

Then, n partial products P₁ to Pₙ output from the selector 20 and one partial product A×2⁻ⁿ output from a right shift circuit 10 are input to a Wallace tree adder 30 serving as an adder which adds the partial products.

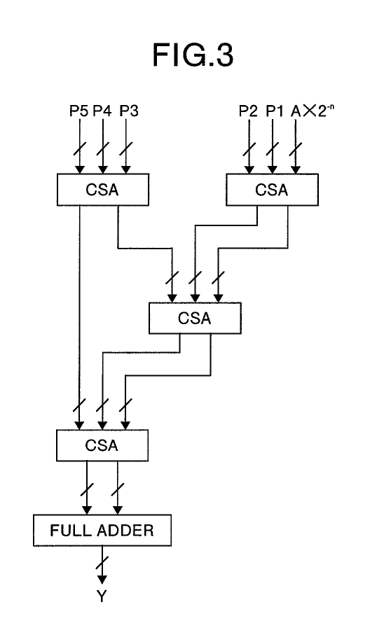

In the Wallace tree adder 30, n+1 input partial products P₁ to Pₙ and A×2⁻ⁿ are added up with due regard to figure alignment. FIG. 3 shows an internal configuration of the Wallace tree adder 30 in a case of n=5. The Wallace tree adder 30 executes addition processing of six partial products with a Wallace tree of three stages using four carry save adders (CSAs) and one full adder.

According to the Wallace tree adder 30 of FIG. 3, in a first stage, six partial products can be narrowed down to four partial products by using two CSAs. In a second stage, one CSA is used for three partial products among the four partial products, and thus the four partial products are narrowed down to 2+1 partial products. In a third stage, the three partial products are narrowed down to two partial products by using one CSA. A final sum is obtained by performing full addition on the two numbers in an ordinary full adder. By taking 10 high-order bits of the resultant sum, a linear filter output Y to be derived is obtained.

In this way, when a linear filter circuit is logically formed on the basis of the equation (5), the number of partial products derived by using the one right shift circuit 10 and the selector 20 becomes (n+1) . By the way, the number of partial products in the case of the conventional art is 2n. Therefore, addition of the partial products can be conducted by using the three-stage Wallace tree using four CSAs, and one full adder. In other words, according to the present embodiment, the number of CSAs in the Wallace tree can be reduced from ten (conventional art) to four and the number of stages of the CSAs can be reduced from five (conventional art) to three, by adopting the right shift circuit 10 and the selector 20 in the configuration which generates partial products of the multiplier. Therefore, it is possible to obtain a linear filter circuit which is reduced in circuit area and which operates fast.

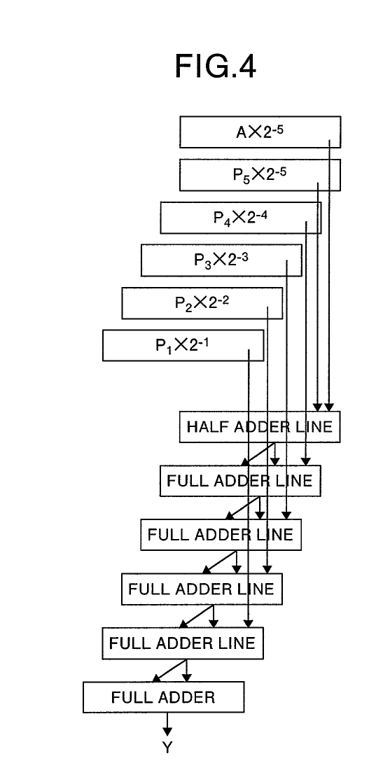

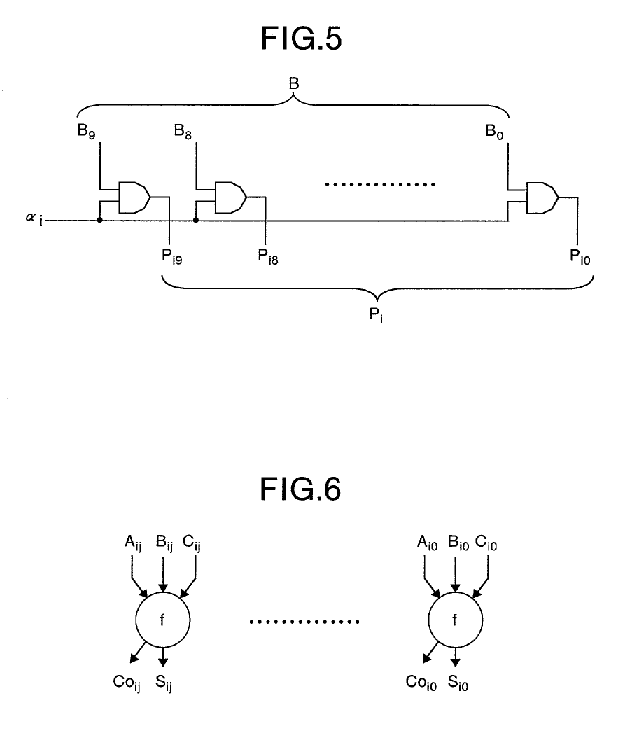

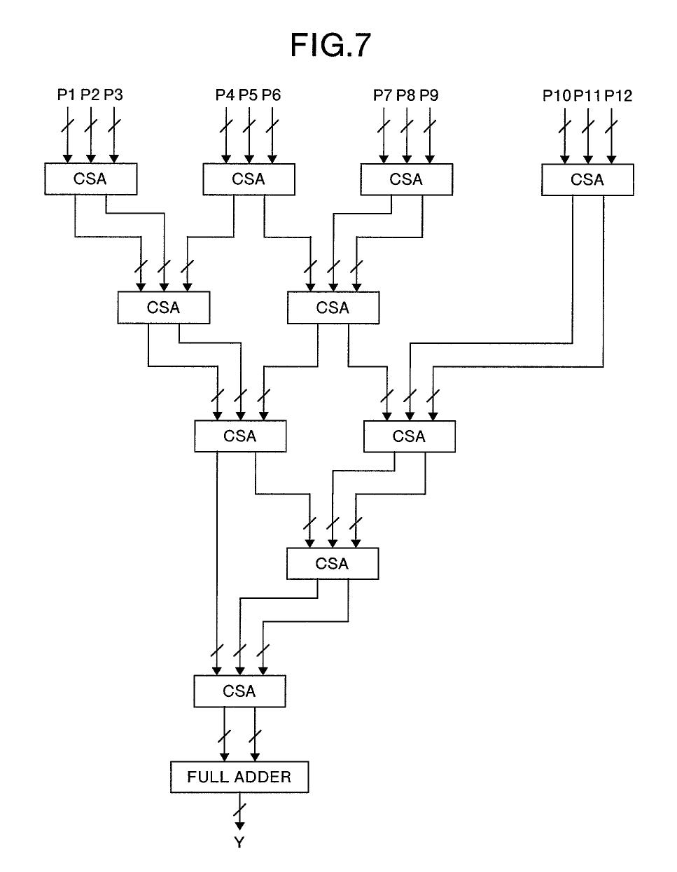

In the embodiment, partial products derived by the right shift circuit 10 and the selector 20 are added by the Wallace tree adder. An arbitrary adder other than the Wallace tree adder may also be used so long as the adder can add up the partial products. For example, if a multiplier using the carry save method is applied to the present invention, the configuration of the adder becomes as shown in FIG. 4. In FIG. 4, derived partial products P₁×2⁻¹ to P₅×2⁻⁵ and A×2⁻⁵ are added by using a half adder line of a first stage, full adder lines of four stages, and a full adder. In this case, modifications, such as alteration of the half adder line of the first stage which adds two numbers to a full adder line which adds three numbers, are also possible.

In this embodiment, an arbitrary number of bits can be adopted for A, B, Y and α. Both numbers having signs and numbers having no signs can be coped with by the same logical configuration as that explained above. Further, the linear filter circuit can also be applied to processing of finding an interior division point of two coordinates (a point which divides a distance between two points into α and 1−α).

As heretofore explained, according to the first aspect of the present invention, the shift circuit derives A×2⁻n by shifting the input pixel value A rightward by n bits. The selector selects either the input pixel value A or the input pixel value B according to the n-bit blending factor α, conducts computation of (A×α_+B×α) , and outputs n partial products. The adder adds up a total of (n+1) partial products output from the selector and the shift circuit, and thereby derives the output value Y=A×(1−α)+B×α. As a result, the number of generated partial products is reduced as compared with the conventional art. Accordingly, a linear filter circuit having a faster speed and a reduced area can be implemented.

Moreover, a plurality of partial products are added up by using the carry save adders of multiple stages of the Wallace tree scheme. By the number of partial products reduced as compared with the conventional art, the number of carry save adders and the number of stages thereof used in the adder can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A linear filter circuit which uses two input pixel values A and B and an n-bit blending factor α, where α is a decimal, computes Y=A×(1−α)+B×α, where A and B are integers, and thereby blends the two input pixel values, the linear filter circuit comprising:
a shift circuit which shifts the input pixel value A rightward by n bits;
a selector which selects either the input pixel value A or the input pixel value B according to the n-bit blending factor α, and outputs n partial products; and
an adder which adds up a total of (n+1) partial products output from said selector and said shift circuit.

2. The linear filter circuit according to claim 1, wherein carry save adders of multiple stages of a Wallace tree scheme are used in said adder.
